(19) United States
(12) Patent Application Publication
(10) Pub. No.: US 2021/0285665 A1
(43) Pub. Date: Sep. 16, 2021

(54) HEAT TRANSFER MODULE FOR DEHUMIDIFIER AND METHOD FOR MANUFACTURING HEAT TRANSFER MODULE

(71) Applicant: LG ELECTRONICS INC., Seoul (KR)

(72) Inventors: Junghoon HA, Seoul (KR); Jongchul HA, Seoul (KR); Inbeom CHEON, Seoul (KR); Sunghoon BAEK, Seoul (KR)

(21) Appl. No.: 17/196,231

(22) Filed: Mar. 9, 2021

(30) Foreign Application Priority Data
Mar. 11, 2020 (KR) 10-2020-0030154

(51) Int. Cl. F24F 3/153; F24F 3/14

(52) U.S. Cl. CPC F24F 3/153; F24F 2003/144; F24F 3/1405

(57) ABSTRACT

A method for manufacturing a heat transfer module for a dehumidifier may include forming a U shaped heat pipe having one straight portion acting as a heat-dissipation pipe, the other straight portion acting as a heat-absorbing pipe, and a connection pipe having a curved shape and connecting the two straight portions; inserting a heat-emitting fin and a heat-absorbing fin into the heat-dissipation pipe and the heat-absorbing pipe, respectively; expanding the heat-dissipation pipe and the heat-absorbing pipe such that the heat-emitting fin and the heat-absorbing fin are fixed to the heat-dissipation pipe and the heat-absorbing pipe, respectively; sealing one end of the heat pipe; injecting working fluid into the heat pipe through the other end of the heat pipe; and sealing the other end of the heat pipe containing therein the working fluid.

### CROSS-REFERENCE TO RELATED APPLICATION

This application claims the benefit of Korean Patent Application No. 10-2020-0030154, filed in Korea on Mar. 11, 2020, whose entire disclosure is hereby incorporated by reference.

### BACKGROUND

### 1. Field

The present disclosure relates to a heat transfer module for a dehumidifier and a method for manufacturing a heat transfer module.

### 2. Background

A dehumidifier may act as an air conditioner to reduce humidity by directly removing moisture in the air. Dehumidifiers may be classified into a cooling type dehumidifier or a drying type dehumidifier.

The drying type dehumidifier may use a desiccant (e.g., a silica gel or another porous substance having an excellent ability to absorb moisture) to directly absorb moisture in the air. When the desiccant can no longer absorb moisture, the desiccant may be heated to separate moisture from the desiccant, which may be discharged out of the dehumidifier so that the desiccant may be used again. This drying type dehumidifier may be useful in removing a small amount of moisture in an enclosed space.

The cooling type dehumidifier may control moisture by condensing water vapor in the air into water. To condense the vapor into the water, a temperature of the air must be lowered below a dew point. The cooling type dehumidifier may use a refrigerant to cool the air. The cooling type dehumidifier may include a compressor, a condenser, an expander, and an evaporator through which refrigerant is circulated.

In one example of a cooling type dehumidifier, dehumidification may be carried out by condensing moisture when air passes through the evaporator. The air that has passed through the evaporator passes through the condenser and is reheated. The dehumidifier may not be intended to cool the air. The air discharged from the dehumidifier may pass through the condenser and thus is heated. The evaporator may only need to lower the temperature of the air to the dew point.

However, since performance of the refrigeration cycle may be designed to sufficiently perform cooling in preparation for a high temperature and high humidity situation, the air passing through the evaporator may be cooled to a temperature lower than a target temperature. On the other hand, when the temperature of the air introduced into the evaporator is lowered, the temperature of the air may be lowered until the temperature of the air reaches the dew point in the evaporator. A dehumidifier using a heat-exchanger having a heat pipe to transfer heat between the air passing through the evaporator and the air flowing into the evaporator has been proposed

In a dehumidifier using to heat-exchanger equipped with a heat pipe, a precooling part of the heat pipe (a portion of the heat pipe at an inlet side) may be provided upstream of the evaporator with respect to an air flow direction, and a heat dissipating part (a portion of the heat pipe at an outlet side) may be placed downstream the evaporator in the air flow direction such that an evaporator load may be reduced and a compressor power consumption may be reduced.

The dehumidifier according to related art has a problem in that an entire thickness of the evaporator may be large because of an evaporation pipe and a horizontal heat pipe being connected to a heat-emitting fin. When manufacturing various models in consideration of a total thickness and power consumption of the dehumidifier, a thick evaporator having a horizontal heat pipe and a thin evaporator not having a horizontal heat pipe must be separately manufactured, which may increase an overall manufacturing cost of the dehumidifier. When coupling the horizontal heat pipe and the heat-emitting fin to each other using a press-fitting method or brazing method according to related art, the heat-emitting fin that may be used may be limited. High-efficiency fins such as corrugate fins or slit fins may not be used when using the press-fitting method or the brazing method according to related art.

### BRIEF DESCRIPTION OF THE DRAWINGS

Embodiments will be described in detail with reference to the following drawings in which like reference numerals refer to like elements, and wherein:

FIG. 1 is a block diagram showing a dehumidifier according to an embodiment;

FIG. 2 is a simplified diagram showing an internal structure of the dehumidifier according to an embodiment;

FIG. 3 is a perspective view showing a heat transfer module according to an embodiment;

FIG. 4 is a side view showing a heat transfer module according to an embodiment;

FIG. 5 is a flow chart showing a manufacturing process of the heat transfer module according to an embodiment;

FIGS. 6 to 10 are exemplary diagrams showing the manufacturing process of the heat transfer module according to an embodiment;

FIG. 11 is a partial perspective view showing a part of a heat transfer module according to another embodiment of the present disclosure; and

FIG. 12 is a partial perspective view showing a part of a heat transfer module according to another embodiment of the present disclosure.

### DETAILED DESCRIPTION

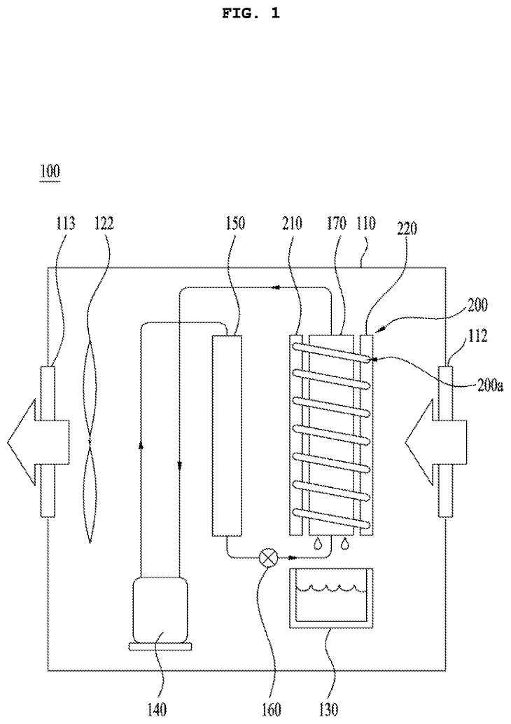

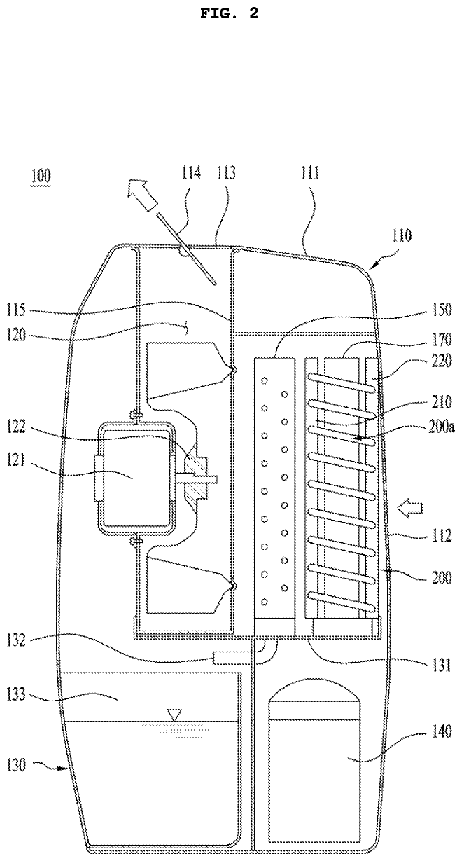

Referring to FIGS. 1-2, a dehumidifier 100 according to an embodiment may include a casing 110 defining an exterior or outer appearance of the dehumidifier 100 and a refrigeration cycle. The refrigeration cycle may include a compressor 140 configured to compress refrigerant, a condenser 150 configured to condense the refrigerant compressed by the compressor 140, an expander 160 configured to expand the refrigerant condensed by the condenser 150, an evaporator 170 configured to evaporate the refrigerant expanded by the expander 160, and a heat transfer module or heat exchanger 200 that absorbs heat of air flowing into the evaporator 170 and transfers the heat to air flowing out of the evaporator 170. The dehumidifier 100 may include a collector 130 (e.g., a cavity or container) that collects and drains condensate produced from the evaporator.

The casing 110 may include an outer cover 111 that defines the exterior or outer appearance of the dehumidifier 100, a fluid channel 120 provided inside the outer cover 111 to define a flow path through which air flows, and a partition or wall 115 that defines the fluid channel 120 and/or the collector 130 in which condensate is collected.

An air inflow hole or opening 112 through which air is introduced from an outside and an air outflow hole or opening 113 through which dehumidified air flows to the outside may be defined in different (e.g., opposite) sides of the outer cover 111 of the casing 110, respectively. In one example, the air inflow hole 112 may be formed by a plurality of through holes or openings. A filter member to filter dust in the air may be further provided at or within the air inflow hole 112.

A cover 114 may open the air outflow hole 113 during operation of the dehumidifier 100 to allow the dehumidified air to be discharged to the outside. The cover 114 may be driven using a motor or actuator, for example, so that the cover may open and/or close the hole 113 in conjunction with the operation of the dehumidifier 100.

In one example, the partition 115 (or alternatively, a plurality of inner walls) may divide an inner space of the outer cover 111 into a fluid channel 120 and the collector 130. The partition 115 may further define a space where the compressor 140 and a controller are installed.

A blowing fan 122 to suction ambient air outside the dehumidifier may be provided in the fluid channel 120 and adjacent to the air outflow hole 113. The blowing fan 122 may discharge air dehumidified in the evaporator 170 and heated in the condenser 150 out of the casing 110 through the air outflow hole 113. This blowing fan 122 may rotate by a motor 121 that generates rotational force. As an example, the blowing fan 122 may be an axial fan.

In the fluid channel 120, the evaporator 170 and the condenser 150 may be sequentially provided along a flow direction of the air moved by the blowing fan 122. The compressor 140 and the expander 160 may be provided outside the fluid channel 120 inside the casing 110 so as not to interfere with the flow of air.

In one example, the compressor 140 may be connected to the evaporator 170 to compress the refrigerant evaporated from the evaporator 170. The compressor 140 may be connected to the condenser 150 and the compressed refrigerant therein may flow to the condenser 150. The condenser 150 may be connected to the compressor 140 and condense the refrigerant compressed by the compressor 140 via heat-exchanging between the refrigerant and air. The condenser 150 may heat the air dehumidified by the evaporator 170. The air heated by the condenser 150 may flow out through the air outflow hole 113 by the blowing fan 122. The condenser 150 may be connected to the expander 160, and the refrigerant condensed in the condenser 150 may flow to the expander 160.

The condenser 150 may be a fin and tube type heat-exchanger having at least one condensing tube through which the refrigerant flows and a condensing fin coupled to the condensing tube and in contact with the air passing through the condenser 150. The expander 160 may be connected to the condenser 150 to expand the refrigerant condensed by the condenser 150. The expander 160 may connect to evaporator 170 so that the refrigerant expanded in the expander 160 may flow to the evaporator 170.

The evaporator 170 may be connected to the expander 160 to evaporate the refrigerant expanded in the expander 160 via heat exchange between the refrigerant and the air. The evaporator 170 may cool and dehumidify the air. The air cooled and dehumidified by the evaporator 170 may flow to the condenser 150.

The evaporator 170 may be connected to the compressor 140, and the refrigerant evaporated in the evaporator 170 may flow to the compressor 140. A part of the heat transfer module 200 may be placed at a front face of the evaporator 170 onto which air flows, and another part of the heat transfer module 200 may be placed at a rear face thereof from which air flows out. The evaporator 170 may be embodied as a fin and tube type heat-exchanger having at least one evaporating tube through which the refrigerant flows and an evaporating fin that is coupled to the evaporating tube and contacts the air passing through the evaporator 170.

In one example, the collector 130 may be provided below the fluid channel 120 in the casing 110. The collector 130 may include a collection plate 131 in a shape of a casing or dish and configured to collect condensate falling from the evaporator 170. The collector 130 may further include a collection pipe 132 extending from a bottom of the collection plate 131 and a collection container 133 that collects and stores the condensate flowing through the collection pipe 132. The collection pipe 132 may communicate with an upper surface of the collection plate 131 to collect fallen condensate, and may guide the condensate toward the collection container 133. The collection container 133 may be formed separately from the outer cover 111 of the casing 110, and may be, for example, be removable (such as a drawer) so that the user may discharge the stored condensate therein.

In one example, the heat transfer module 200 may be provided on or at the front face of the evaporator 170 onto which air is introduced and the rear face of the evaporator 170 from which air is discharged. The heat transfer module 200 may cool the air flowing into the evaporator 170 and heat the air flowing out from the evaporator 170. This heat transfer module 200 may pre-cool the air to be introduced into the evaporator 170 in the air flow direction of the air, and preheat the air that has passed through the evaporator 170 again, such that a load of the evaporator 170 may be reduced and power consumption of the compressor 140 may be reduced.

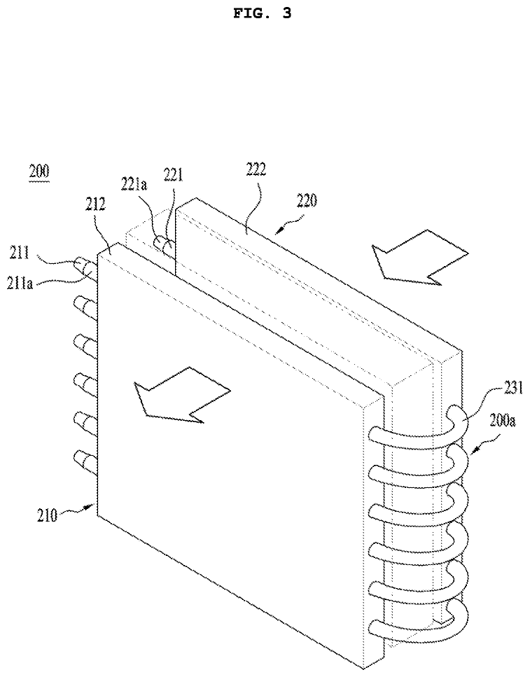

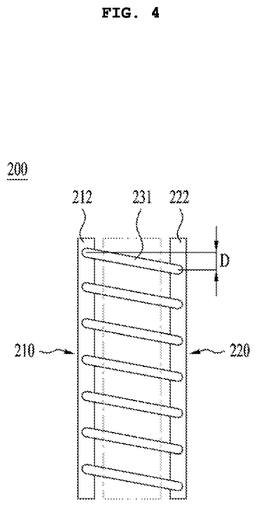

Hereinafter, the heat transfer module 200 will be described in detail with reference to the accompanying drawings. As shown in FIGS. 3 to 4, the heat transfer module 200 according to an embodiment may include a heat-absorber 220 provided adjacent to the front face of the evaporator 170 and a heat-emitter 210 connected to the heat-absorber 220 and provided adjacent the rear face of the evaporator 170.

This heat transfer module 200 may include a heat-absorbing pipe 221 extending across the front face of the evaporator 170, a connection pipe 231 that curves and extends from the heat-absorbing pipe 221 along a lateral face of the evaporator 170 to the rear face of the evaporator 170, and a heat-dissipation pipe 211 extending from the connection pipe 231 and across the rear face of the evaporator 170. The above pipes 221, 231 and 211 may form a single heat pipe 200a. A plurality of heat pipes 200a may be arranged in a vertical direction of the evaporator 170.

In one example, a heat-absorbing fin 222 may be provided between the heat-absorbing pipes 221 of the heat pipes 200a to define a heat-absorbing area while contacting the air introduced into the evaporator 170. A heat-emitting fin 212 may be provided between the heat-dissipation pipes 211 of the heat pipes 200a to define a heat-emitting area while contacting the air passing through the evaporator 170.

The heat-absorbing pipe 221 and the heat-dissipation pipe 211 of a single heat pipe 200a may be positioned at different vertical levels or heights. The heat-absorbing pipe 221 may be provided at a predetermined height of the evaporator 170, and the heat-dissipation pipe 211 may be positioned at a height higher, by a predetermined vertical dimension or distance D, than the predetermined height of the heat-absorbing pipe 221. The heat-absorbing pipe 221 may not align, in a front-rear direction, with the heat-dissipation pipe 211. The connection pipe 231 may be inclined or curved upward to connect the lower heat-absorbing pipe 221 to the higher heat-dissipation pipe 211.

In one example, the heat-absorbing pipe 221 and the heat-dissipation pipe 211 may extend horizontally across the front face and the rear face of the evaporator 170, respectively. The connection pipe 231 connecting the heat-absorbing pipe 221 and the heat-dissipation pipe 211 to each other may extend in an inclined manner and in a predetermined curvature manner across a lateral face of the evaporator.

When the vertical levels or heights of the heat-absorbing pipe 221 and the heat-dissipation pipe 211 are different from each other by the predetermined vertical dimension D, liquid fluid in the heat pipe 200a may easily flow downward toward the heat-absorbing pipe 221 due to a weight of the liquid fluid so that a heat flow along the heat pipe 200a may be enhanced.

The heat-absorber 220 may be located upstream of the evaporator 170 in the air flow direction and d between the air inflow hole 112 and the evaporator 170. Air passing through the air inflow hole 112 and then flowing toward the evaporator 170 may be pre-cooled by the heat-absorber 220. In one example, the heat-absorber 220 may be spaced apart from front faces of the evaporating fin and the evaporating tube of the evaporator 170 by a predetermined spacing.

The heat-emitter 210 may be located between the evaporator 170 and the condenser 150 and downstream of the evaporator 170 in the air flow direction. The air cooled and dehumidified while passing through the evaporator 170 may be heated by the heat-emitter 210. In one example, the heat-emitter 210 may be spaced apart from rear faces of the evaporating fin and the evaporating tube of the evaporator 170 by a predetermined spacing.

The heat pipe 200a may be made of a metal material (e.g., copper, aluminum, etc.) Both ends of the single heat pipe 200a may be sealed to maintain a vacuum therein. The pipe may be filled with a volatile fluid (e.g., methanol, acetone, water, mercury, etc.) capable of changing a phase thereof into a gas phase for heat transfer. When this volatile fluid is in a liquid state, the fluid may flow along an inner wall surface of the heat pipe 200a. When the fluid is in the gas phase, the fluid may flow along a center of the heat pipe 200a.

In one example, the evaporator 170 as described above may be embodied as the fin and tube type heat-exchanger. The heat-dissipation pipe 211 and the heat-absorbing pipe 221 of the single heat pipe 200a may be provided at vertical levels or heights different from that of the evaporating tube of the evaporator. Since the heat-dissipation pipe 211 and the heat-absorbing pipe 221 of the heat pipe 200a are located in a flow path of the air, the heat pipe 200a may act as flow resistance in the air flow direction. When arranging the heat-dissipation pipe 211, the heat-absorbing pipe 221, and the evaporating tube of the evaporator 170 at different heights or in different vertical levels, a flow resistance of the air suctioned toward the evaporator 170 may be reduced.

The heat pipes 200a as described above may surround the evaporator 170 and be arranged in the vertical direction of the evaporator 170. The heat-absorbing fin 222 may be provided between the heat-absorbing pipes 221 of the heat pipes 200a. The heat-emitting fin 212 may be provided between the heat-dissipation pipes 211 of the heat pipes 200a.

The heat-absorbing fin 222 may be formed by bending a metal plate in a vertical direction such that the heat-absorbing fin 222 may be fixed to a lower heat-absorbing pipe 221 and an upper heat-absorbing pipe 221 via adhesive, brazing, welding, etc. The heat-absorbing fin 222 may pre-cool the air via heat exchange between the fluid therein and the air about to flow to the evaporator 170.

The heat-emitting fin 212 may be formed by bending a metal plate in a vertical direction such that the heat-emitting fin 212 may be fixed to a lower heat-dissipation pipe 211 and an upper heat-dissipation pipe 211 via adhesive, brazing, welding, etc. The heat-emitting fin 212 may heat the air via heat exchange between the fluid therein and the air that has passed through the evaporator.

In one example, a spacing between the heat-emitting fins 212 and a spacing between the heat-absorbing fins 222 may be different from each other. A number of heat-absorbing fins 222 and the number of heat-emitting fins 212 may be different from each other. The heat-absorbing fin 222 and the heat-emitting fin 212 may have different positions. One of the heat-absorbing fin 222 and the heat-emitting fin 212 may be closer to the evaporating fin of the evaporator 170, while the other of the heat-absorbing fin 222 and the heat-emitting fin 212 may be placed further away from the evaporating fin.

In one example, the heat transfer module 200 as described above may be manufactured by coupling the heat-emitting fin 212 and the heat-absorbing fin 222 to the heat pipe 200a. Hereinafter, the manufacturing process of the heat transfer module 200 according to an embodiment will be described in detail with reference to the accompanying drawings.

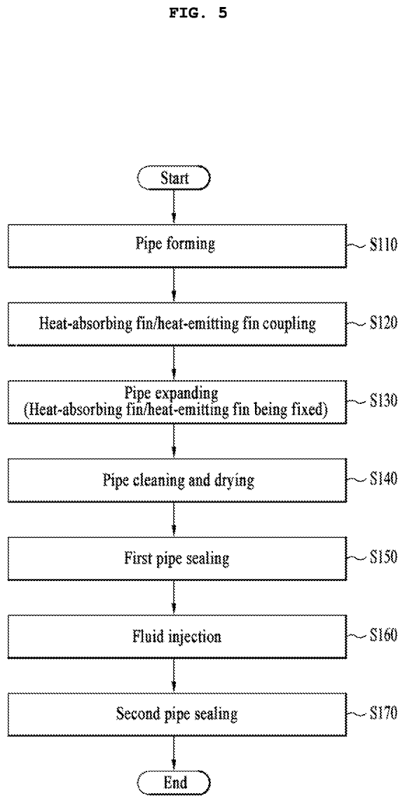

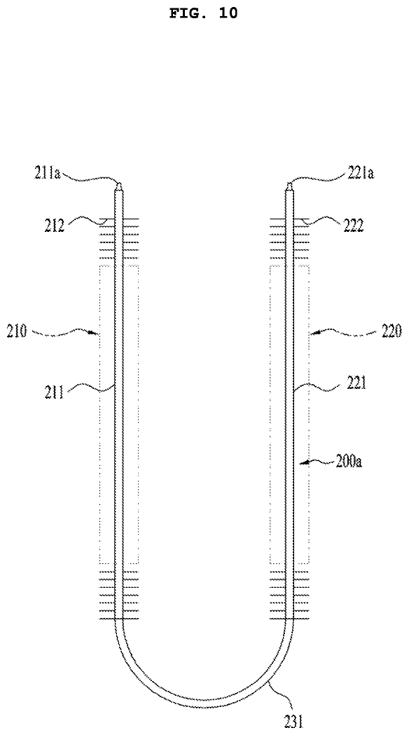

Referring to FIGS. 5-10, a manufacturing process of the heat transfer module according to an embodiment may include forming a pipe S110, coupling a heat-absorbing fin/heat-emitting fin S120, expanding a pipe S130, cleaning and drying a pipe S140, sealing a pipe a first time S150, injecting a fluid S160, and sealing a pipe a second time S170.

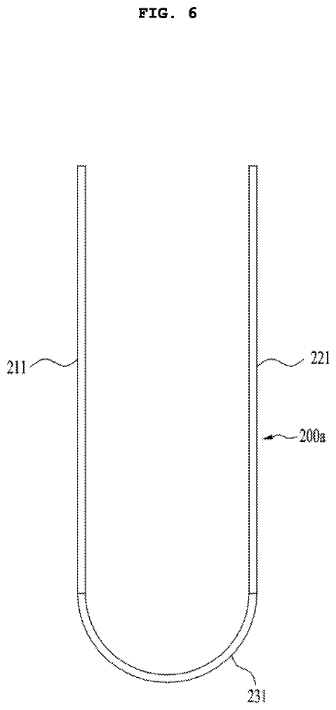

Forming the pipe S110 may include forming a pipe made of a non-ferrous metal material, (e.g., copper, aluminum, etc.) and having a predetermined diameter into the heat pipe 200a having the heat-dissipation pipe 211 corresponding to the heat-emitter 210, the heat-absorbing pipe 221 corresponding to the heat-absorber 220, and the connection pipe 231 connecting the heat-dissipation pipe 211 and the heat-absorbing pipe 221, as shown in FIG. 6. The heat pipe 200a according to the present disclosure may be made of a material having high thermal conductivity, such as copper (Cu) or aluminum (Al). However, embodiments disclosed herein are not limited thereto.

For example, a thermal conductivity of copper is 300 to 340 kilocalories per degree Celsius (kcal/° C.). A thermal conductivity of aluminum is about 175 kcal/° C. Copper may be mainly used because copper has a heat transfer ability about two times greater than that of aluminum. However, aluminum may be lighter than copper, a recycling cost of aluminum may be low, and aluminum may be a less environmentally harmful substance. Recently, aluminum has been used for automobiles and industrial applications.

The connection pipe 231 may be formed by cutting a manufactured pipe to a certain length and then bending a part or portion corresponding to the connection pipe 231 in an arc shape so that an entirety of the heat pipe 200a may be bent in a ‘U’ shape.

A straight portion of the heat pipe 200a bent in the ‘U’ shape may correspond to the heat-dissipation pipe 211, and the other straight portion thereof may correspond to the heat-absorbing pipe 221. A curved portion connecting the heat-dissipation pipe 211 and the heat-absorbing pipe 221 to each other may correspond to the connection pipe 231.

In one example, the heat pipe 200a as described above may have a diameter, a number, a length, etc. varying according to a size or a capacity of the heat transfer module 200. A plurality of heat pipes 200a may be formed by repeatedly performing the forming the pipe S110.

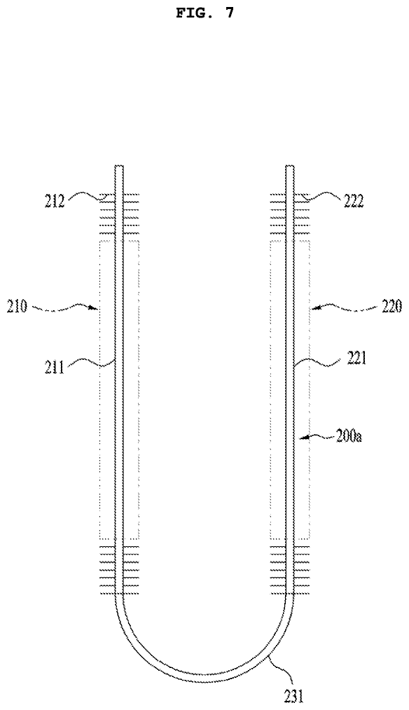

Thereafter, coupling the heat-absorbing fin/heat-emitting fin S120 may include coupling the heat-emitting fin 212 and the heat-absorbing fin 222, respectively, to the heat-dissipation pipes 211 and the heat-absorbing pipes 221 of the plurality of heat pipes 200a, as shown in FIG. 7.

The heat-absorbing fin 222 and heat-emitting fin 212 may be positioned on the heat-absorbing pipe 221 and the heat-dissipation pipe 211, respectively. The heat-absorbing fin 222 and heat-emitting fin 212 may be respectively coupled to the heat-adsorbing pipe 221 and the heat-dissipation pipe 211 in substantially the same manner, though functions of the heat-absorber 220 and the heat-emitter 210 may be different from each other.

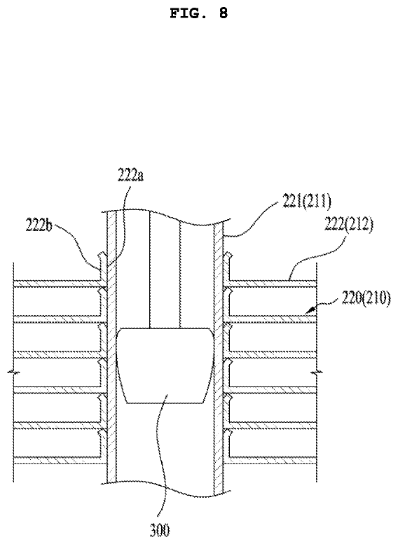

In one example, each of the heat-absorbing fin 222 and the heat-emitting fin 212 as described above may have an area, a thickness, and a number varying according to a size or capacity of the heat transfer module 200. Further, each of the heat-absorbing fin 222 and the heat-emitting fin 212 may have respectively pipe-receiving openings 212a and 222a (FIG. 8) defined therein having diameters larger than outer diameters of the plurality of the heat pipes 200a. A number of the pipe-receiving openings may vary based on a number of the heat pipes 200a. On an inner circumference face of each of the pipe-receiving openings 212a and 222a, ribs 212b and 222b (FIG. 8) extending in a direction parallel to an insertion direction of the heat-absorbing pipe 221 and the heat-dissipation pipe 211 may be formed.

In one example, the pipe-receiving opening 212a formed in the heat-emitting fin 212 may be located at a level higher by the predetermined vertical dimension D (see FIG. 4) than a level of the pipe-receiving opening 222a defined in the heat-absorbing fin 222. Due to the difference in the vertical level between the heat-dissipation pipe 211 inserted into the opening of the heat-emitting fin 212 and the heat-absorbing pipe 221 inserted into the heat-absorbing fin 222, the liquid fluid filled in the heat pipe 200a may easily flow toward the heat-absorbing pipe 221, which has a relatively lower height than that of the heat-dissipation pipe 211 due to its own weight, so that the heat flow of the heat pipe 200a may be enhanced.

In one example, a gap for insertion of the heat-absorbing pipe 221 may be formed between the heat-absorbing pipe 221 and the opening 222a of the heat-absorbing fin 222 into which the heat-absorbing pipe 221 is inserted. When expanding the heat-absorbing pipe 221, the heat-absorbing fin 222 may be fixed to an outer peripheral surface of the heat-absorbing pipe 221. Further, a gap for insertion of the heat-dissipation pipe 211 may be formed between the heat-dissipation pipe 211 and the opening of the heat-emitting fin 212 into which the heat-dissipation pipe 211 is inserted. When expanding the heat-dissipation pipe 211, the heat-emitting fin 212 may be fixed to the outer peripheral surface of the heat-dissipation pipe 211.

In one example, expanding the pipe S130 may expand the heat-absorbing pipe 221 and the heat-dissipation pipe 211 such that the heat-absorbing pipe 221 and the heat-dissipation pipe 211 may be fixed to the heat-absorbing fin 222 and the heat-emitting fin 212, respectively. The fixing of the heat-absorbing pipe 221 to the heat-absorbing fin 222 and the fixing of the heat-dissipation pipe 211 to the heat-emitting fin 212 may be carried out in the same expanding process. Hereinafter, an example in which the expansion of the heat-absorbing pipe 221 may allow the heat-absorbing pipe 221 to be fixed to the heat-absorbing fin 222 will be described.

In expanding the pipe S130, while the heat-absorbing pipe 221 is inserted into the opening 222a of the heat-absorbing fin 222 as shown in FIG. 8, an expander 300 (e.g., an insertable rod with a large or expanding end) may be inserted into the opening to mechanically expand inner and outer diameters of the absorbing pipe 221. As the inner and outer diameters of the heat-absorbing pipe 221 expand, the outer diameter of the heat-absorbing pipe 221 may closely contact the rib 222b of the heat-absorbing fin 222, and the heat-absorbing fin 222 may be fixed to the heat-absorbing pipe 221.

In expanding the pipe S130, various types of the heat-absorbing fins 222 or the heat-emitting fins 212 may be used. For example, a brazing process may be used to couple the existing heat-absorbing fin 222 or the heat-emitting fin 212 to the heat pipe 200a using a brazing process. Brazing may refer to a technique of bonding two bases to each other by applying heat to a filler without causing damage to the base at a temperature below a melting point of the base at 450 degrees C. or higher. The filler having a liquidus temperature of 450 degrees C. or higher may be used, and two bases may be bonded to each other by applying heat below a solidus temperature of the base to the filler.

However, brazing may not be used for fixing various types of heat-absorbing fins 222 or heat-emitting fins 212. Brazing the heat-absorbing fin 222 or the heat-emitting fin 212 may generally require that the heat-absorbing fin 222 or the heat-emitting fin 212 has a simple shape and predetermined thickness or gauge (e.g., about 0.3 t or larger). Brazing may not be used when a corrugate or a slit fin is used for the heat-absorbing fin 222 or the heat-emitting fin 212 to increase a heat transfer area. When using brazing, any reduction in the thickness of the heat-absorbing fin 222 or the heat-emitting fin 212 should be limited, making it difficult to increase the number of heat-absorbing fins 222 or heat-emitting fins 212.

According to the present disclosure, various types of heat-absorbing fins 222 or heat-emitting fins 212 may be used due to expanding the pipe S130 of the heat pipe 200a. The number of the heat-absorbing fins 222 or heat-emitting fins 212 may be increased by reducing the thickness of the heat-absorbing fin 222 or heat-emitting fin 212.

In one example, cleaning and drying the pipe S140 may remove foreign substances remaining inside the heat-absorbing pipe 221, the heat-dissipation pipe 211, and the connection pipe 231 during forming the pipe S110, coupling the heat-absorbing fin/heat-emitting fin S120, and expanding the pipe S130. Cleaning and drying the pipe S140 may remove foreign substances inside the heat pipe 200a by spraying high-pressure cleaning water or air through the opening of the heat pipe 200a (i.e., the opening of the heat-absorbing pipe 221 or the heat-dissipation pipe 211). The heat pipe 200a subject to the cleansing may be dried for a certain or predetermined period of time so that the cleaning water used for cleaning is removed or evaporated.

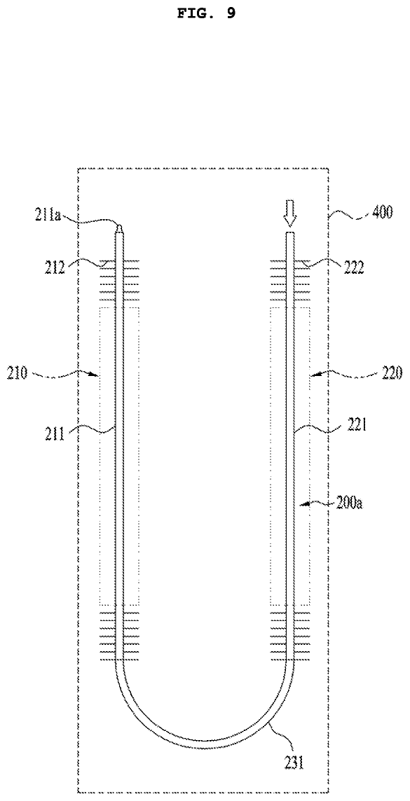

In one example, the sealing the first pipe S150 may seal one opening of the heat pipe 200a (i.e., either the opening of the heat-absorbing pipe 221 or the opening the heat-dissipation pipe 211) as shown in FIG. 9. The remaining, unsealed opening may be opened such that working fluid is input inside the pipe 200a through the remaining opening. In FIG. 9, the opening of the heat-dissipation pipe 211 is sealed while the opening of the heat-absorbing pipe 221 remains opened, but alternatively, the opening of the heat-absorbing pipe 221 may be sealed while the opening of the heat-dissipation pipe 211 remains opened. The sealing the first and second pipes S150 and S170 will hereinafter be described as sealing the heat-dissipation pipe 211 in sealing the first pipe p S150 and sealing the heat-absorbing pipe 221 in sealing the second pipe S170 as an example.

Sealing the first pipe S150 may form a first sealing portion 211a by inserting a separate plug into the opening of the heat-dissipation pipe 211 and welding the plug to the heat-dissipation pipe 211. Alternatively, the first sealing portion 211a may be formed by directly welding shut the opening of the heat-dissipation pipe 211.

In one example, injecting the fluid S160 may inject a working fluid into the heat-absorbing pipe 221, which may be unsealed. The working fluid may be a liquid having a low boiling point, but embodiments disclosed herein are not limited. For example, the working fluid may alternatively be a gaseous fluid. When liquid is used as the working fluid, methyl alcohol may be mainly used, but embodiments disclosed herein are not limited thereto. Various kinds of materials may be used as the working fluid as long as the fluid has a relatively low boiling point. Hereinafter, the present disclosure will be described based on an example in which the working fluid is liquid.

After the heat transfer module 200 is manufactured, the working fluid in the heat pipe 200a may absorb heat from the heat-absorber 220 and may change to a gaseous state and flow toward the heat-emitter 210 to emit or dissipate heat. The working fluid that emits the heat toward the heat-emitter 210 may be converted back into the liquid state and may be transferred to the heat-absorber.

As previously explained, a liquid with a low boiling point such as methyl alcohol may be mainly used as the working fluid. An appropriate heat medium may be selected in consideration of the characteristics of the dehumidifier 100 in which the heat transfer module is installed and a heat emission amount of a peripheral device, for example, the evaporator 170.

In one example, the working fluid may be injected through the unsealed opening of the heat pipe using a separate injection device. For example, the working fluid may be injected such that the fluid occupies 15 to 30% of an internal volume of the heat pipe 200a.

As described above, the working fluid may absorb heat from the heat-absorber 220, change to a gaseous state, and flow to the heat-emitter 210. The working fluid may then change to a liquid state and flow to the heat-absorber 220. This circulation may be repeated. In consideration of the flow of the working fluid in the gaseous state, the injection amount of the liquid state may be adjusted. Injecting the fluid S160 may inject the working fluid in a state in which air inside the heat pipe 200a is removed by placing the heat pipe 200a in a vacuum chamber or using a vacuum or suction device, for example.

Sealing the second pipe S170 may maintain an inside of the heat pipe 200a in a vacuum state by completely sealing the inside of the heat pipe 200a by sealing the heat-absorbing pipe 221. Sealing the second pipe S170 may be executed with a vacuum device to prevent external air from flowing back into the heat pipe 200a.

The second sealing of the heat pipe 200a may form a second sealing portion 221a by inserting a separate plug into the heat-absorbing pipe 221 and welding the plug. Alternatively, the second sealing portion 221a may be formed via direct high-frequency welding of the heat-absorbing pipe 221.

In one example, sealing the first pipe sealing S150, injecting the fluid S160, and sealing the second pipe S170 may use those used in the manufacturing method of the conventional heat pipe 200a. Therefore, the detailed description thereof will be omitted. In one example, the heat-emitting fin 212 and the heat-absorbing fin 222 of the heat transfer module 200 according to the embodiment of the present disclosure as described above may have various forms in order to improve a contact area with the air passing through the heat-emitter and the heat-absorber.

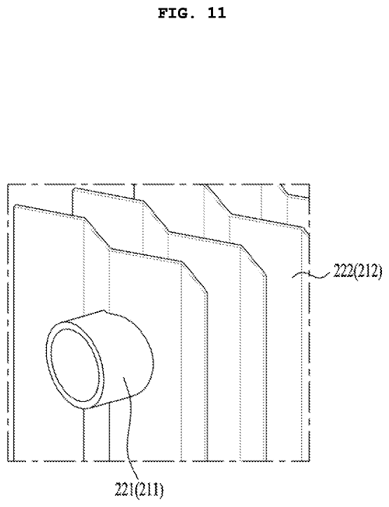

Hereinafter, another embodiment of a heat-emitting fin or a heat-absorbing fin will be described with reference to the accompanying drawings. Referring to FIG. 11, the heat-absorbing fin 222 or the heat-emitting fin 212 according to another embodiment of the present disclosure may be embodied as a corrugate fin. The heat-absorbing fin 222 or the heat-emitting fin 212 may have a corrugate shape having a plurality of peak and valley lines in an air flow direction or in a direction orthogonal to the air flow direction. The heat-absorbing fin 222 or the heat-emitting fin 212 embodied as the corrugate fin may increase a contact area with the air passing between the fins to improve heat exchange efficiency of the heat-absorbing fin 222 or the heat-emitting fin 212.

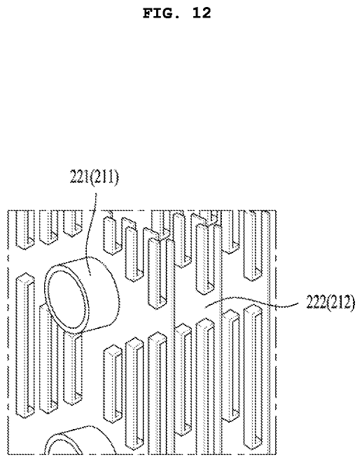

Referring to FIG. 12, the heat-absorbing fin 222 or the heat-emitting fin 212 according to another embodiment of the present disclosure may be embodied as a slit fin. The heat-absorbing fin 222 or the heat-emitting fin 212 may have a surface on which a plurality of partially cut protrusions extend in a direction crossing the flow direction of air. The heat-absorbing fin 222 or the heat-emitting fin 212 having the slit fin may increase a contact area with air passing between the fins to improve heat exchange efficiency of the heat-absorbing fin 222 or the heat-emitting fin 212.

Embodiments disclosed herein may provide a heat transfer module for a dehumidifier provided on a front face and a rear face of an evaporator used in a dehumidifier to assist heat exchange of air passing through the evaporator, and a method for manufacturing the heat transfer module. Embodiments disclosed herein may provide a method for manufacturing a heat transfer module for a dehumidifier in which a manufacturing process of the heat transfer module composed of a heat pipe and a heat transfer fin may be improved so that high-efficiency fins may be used. Embodiments disclosed herein may provide a heat transfer module for a dehumidifier manufactured by the method. Embodiments disclosed herein may provide a manufacturing process of a heat transfer module composed of a heat pipe and a heat transfer fin which is improved so that efficiency of the heat transfer module may be improved, and provide a heat transfer module for a dehumidifier manufactured by the method.

Other advantages of the present disclosure as not mentioned above may be understood from following descriptions and more clearly understood from embodiments of the present disclosure. Further, it will be readily appreciated that the d advantages of the present disclosure may be realized by features and combinations thereof as disclosed in the claims.

Embodiments disclosed herein may provide a method for manufacturing a heat transfer module for a dehumidifier. The dehumidifier may comprise a condenser to condense refrigerant, an evaporator to evaporate the refrigerant, and a heat transfer module to absorb heat from air to be fed into the evaporator and transfer the heat to air flowing out of the evaporator.

The method may comprise heat pipe forming, coupling, expanding, cleaning, first sealing, injection, and second sealing. The heat pipe forming may include forming a U-shaped heat pipe having one straight portion acting as a heat-dissipation pipe, the other straight portion acting as a heat-absorbing pipe, and a connection pipe having a curved shape and connecting the two straight portions. The coupling may include inserting a heat-emitting fin and a heat-absorbing fin into the heat-dissipation pipe and the heat-absorbing pipe, respectively.

The expanding may include expanding the heat-dissipation pipe and the heat-absorbing pipe such that the heat-emitting fin and the heat-absorbing fin are fixed to the heat-dissipation pipe and the heat-absorbing pipe, respectively. The cleaning may include cleaning an inside of the heat pipe. The first sealing may include sealing one end of the heat pipe. The injection may include injecting working fluid into the heat pipe through the other end of the heat pipe. The second sealing may include sealing the other end of the heat pipe containing therein the working fluid.

In one implementation, the heat pipe forming may include bending a straight pipe at a position of the connection pipe. In one implementation, the heat-absorbing fin may have a heat-absorbing pipe receiving opening into which the heat-absorbing pipe is inserted. The heat-emitting fin may have a heat-dissipation pipe receiving opening into which the heat-dissipation pipe is inserted. The heat-dissipation pipe receiving opening may have a vertical level higher than a vertical level of the heat-absorbing pipe receiving opening. In one implementation, a rib may extend from each of the heat-absorbing pipe receiving opening and the heat-dissipation pipe receiving opening such that each rib supports each of the heat-absorbing pipe and the heat-dissipation pipe.

In one implementation, the method may further comprise drying after the cleaning. The injection may include injecting the working fluid in a vacuum state in a vacuum chamber.

In one implementation, the heat-emitting fin or the heat-absorbing fin may include a corrugate fin. In one implementation, the heat-emitting fin or the heat-absorbing fin may include a slit fin.

In one implementation, the first sealing, the injection, and the second sealing may be performed after the expanding. In one implementation, the pipe forming, the coupling, the expanding, the cleaning, the first sealing, the injection, and the second sealing may be performed in this order.

Embodiments disclosed herein may be implemented as a heat transfer module for a dehumidifier. The dehumidifier may comprise a condenser to condense refrigerant, an evaporator to evaporate the refrigerant, and a heat transfer module to absorb heat from air to be fed into the evaporator and transfer the heat to air flowing out of the evaporator. The heat transfer module may include a plurality of heat pipes and a plurality of heat fins. The plurality of heat pipes may be arranged in a vertical direction of the evaporator. Each heat pipe may include a heat-absorbing pipe extending along a front face of the evaporator, a heat-dissipation pipe extending along a rear face of the evaporator, and a connection pipe connecting the heat-absorbing pipe and the heat-dissipation pipe to each other. The plurality of fins may include a heat-absorbing fin and a heat-emitting fin. The heat-absorbing fin may be coupled to each heat-absorbing pipe and exchange heat with air upstream of the evaporator. The heat-emitting fin may be coupled to each heat-dissipation pipe and exchange heat with air downstream of the evaporator. A vertical level or height of each heat-dissipation pipe of each heat pipe may be higher than a vertical level of each heat-absorbing pipe of each heat pipe.

In one implementation, the heat-absorbing fin may have a heat-absorbing pipe receiving opening having a diameter larger than an outer diameter of the heat-absorbing pipe. A rib may extend from an inner circumference face of the opening and contact an outer circumference face of the heat-absorbing pipe. In one implementation, after the heat-absorbing pipe is inserted into the heat-absorbing pipe receiving opening, the heat-absorbing pipe may be expanded and fixed to the rib.

The heat-emitting fin may have a heat-dissipation pipe receiving opening having a diameter larger than an outer diameter of the heat-dissipation pipe. A rib may extend from an inner circumferential surface of the opening and contact an outer circumferential surface of the heat-dissipation pipe. In one implementation, after the heat-dissipation pipe is inserted into the heat-dissipation pipe receiving opening, the heat-dissipation pipe may be expanded and fixed to the rib. After the heat-absorbing fin and the heat-emitting fin are coupled to the heat-absorbing pipe and the heat-dissipation pipe, respectively, working fluid may be injected into the heat pipe, and then the heat pipe may be sealed.

The heat-emitting fin or the heat-absorbing fin may include a corrugate fin. The heat-emitting fin or the heat-absorbing fin may include a slit fin.

Embodiments disclosed herein may be implemented as a heat transfer module for a dehumidifier provided on a front face and a rear face of the evaporator used in the dehumidifier to assist heat exchange of air passing through the evaporator, and a method for manufacturing the heat transfer module.

Embodiments disclosed herein may provide a manufacturing process of the heat transfer module composed of a heat pipe and a heat transfer fin that may be improved so that high-efficiency fins may be used, and provide the heat transfer module for the dehumidifier manufactured by this process. Embodiments disclosed herein may provide a manufacturing process of a heat transfer module composed of a heat pipe and a heat transfer fin which may be improved so that efficiency of the heat transfer module may be improved, and provide the heat transfer module for the dehumidifier manufactured by this process.

Embodiments disclosed herein may be implemented as a method for manufacturing a heat transfer module for a dehumidifier, comprising forming a heat pipe having a U-shape defined by a first pipe having a first end, a second pipe having a second end, and a third pipe which may be curved to join the first and second pipes, inserting the first pipe into a first fin and the second pipe into a second fin, expanding the first pipe and the second pipe to fix the first pipe to the first fin and the second pipe to the second fin, cleaning an inside of the heat pipe, sealing the first end, injecting working fluid into the second end, and sealing the second end. The forming the heat pipe may include bending the third pipe.

The first fin may have a first receiving opening into which the first pipe may be inserted. The second fin may have a second receiving opening into which the second pipe may be inserted. The first receiving opening may be positioned higher in the first fin than the second receiving opening may be positioned in the second fin such that the first pipe may be coupled to the first fin at a position higher than a position where the second pipe may be coupled to the second fin.

At least one first rib may extend from the first fin at the first receiving opening. At least one second rib may extend from the second fin at the second receiving opening such that the first rib supports the first pipe and the second rib supports the second pipe.

The method may further comprise, after the cleaning, drying an inside of the first and second pipes. The injecting may include creating a vacuum state in the heat pipe and injecting the working fluid while the heat pipe may be in the vacuum state.

At least one of the first fin or the second fin may include a corrugated fin. At least one of the first fin or the second fin may include a slit fin.

The sealing the first pipe, the injecting, and the sealing the second pipe may be performed after the expanding. The forming the pipe may be performed before the inserting of the first and second pipes, the inserting may be performed before the expanding, the expanding may be performed before the cleaning, the cleaning may be performed before the sealing the first pipe, the sealing the first pipe may be performed before the injecting, and the injecting may be performed before the sealing the second pipe.

The first fin may be configured to be provided at a first side of an evaporator of the dehumidifier to dissipate heat. The second fin may be configured to be provided at a second side of the evaporator to absorb heat.

Embodiments disclosed herein may be implemented as a heat transfer module for a dehumidifier comprising a plurality of heat pipes configured to be arranged in a vertical direction of an evaporator of the dehumidifier. Each heat pipe may include a first pipe configured to extend along a first surface of the evaporator, a second pipe configured to extend along a second surface of the evaporator, and a third pipe connecting the first pipe and the second pipe to each other and configured to extend across a side of the evaporator that joins the first and second surfaces.

The heat transfer module may further comprise a first fin coupled to each first pipe and configured to exchange heat with air at the first surface of the evaporator, and a second fin coupled to each second pipe and configured to exchange heat with air at the second surface of the evaporator. The first pipes may be not aligned with the second pipes such that the first pipes may be provided at different heights from the second pipes.

The first fin may include an opening having a diameter larger than an outer diameter of the first pipe, and a rib extending from an inner circumferential surface of the first fin that defines the opening. The rib may be configured to contact an outer circumferential surface of the first pipe when the first pipe may be inserted into the opening.

After the first pipe may be inserted into the opening, the first pipe may be configured to be expanded to be fixed to the first fin and supported by the rib. After the first fin and the second fin may be coupled to the first pipe and the second pipe, respectively, one of the first fin and the second fin may be configured to receive working fluid and then be sealed.

At least one of the first fin or the second fin may include a corrugate fin. At least one of the first fin or the second fin may include a slit fin.

The first fin may be configured to absorb heat from the air. The second fin may be configured to dissipate heat to the air. The third pipe may be inclined such that the first pipe may be provided at a lower height than the second pipe.

Embodiments disclosed herein may be implemented as a dehumidifier, comprising a case having an inlet and an outlet, a fan configured to suction air through the inlet and discharge air out the outlet, an evaporator provided adjacent to the inlet having a first side facing the inlet and a second side opposite to the first side, and a heat transfer module. The heat transfer module may include a first fin provided between the first side of the evaporator and the inlet, a second fin provided at the second side of the evaporator, and a plurality of heat pipes.

Each heat pipe may include a first pipe penetrating the first fin and configured to exchange heat with air suctioned through the inlet before the air has passed through the evaporator, a second pipe penetrating the second fin and configured to exchange heat with air that has passed through the evaporator, and a third pipe joining the first and second pipes and extending across a third side of the evaporator that joins the first and second sides. The third pipe may be inclined such that the first pipe may be provided below the second pipe.

Each heat pipe may be configured to be sealed to maintain a vacuum state therein, and a working fluid may be provided inside of each pipe. A condenser may be provided at the second side of the evaporator. The second fin may be provided between the condenser and the evaporator.

Effects of the present disclosure are not limited to the above effects. Those skilled in the art may readily derive various effects of the present disclosure from various configurations of the present disclosure.

Descriptions of the presented embodiments are provided to enable any person skilled in the art of the present disclosure to use or implement the present disclosure. Various modifications to these embodiments will be apparent to those skilled in the art of the present disclosure. The general principles defined herein may be applied to other embodiments without departing from the scope of the present disclosure. Thus, the present disclosure should not be limited to the embodiments presented herein, but should be interpreted in the broadest scope consistent with the principles and novel features presented herein.

For simplicity and clarity of illustration, elements in the figures are not necessarily drawn to scale. The same reference numbers in different figures denote the same or similar elements, and as such perform similar functionality. Furthermore, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be provided directly on or beneath the second element or may be provided indirectly on or beneath the second element with a third element or layer being provided between the first and second elements or layers. It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for manufacturing a heat transfer module for a dehumidifier, comprising:
forming a heat pipe having a U-shape defined by a first pipe having a first end, a second pipe having a second end, and a third pipe which is curved to join the first and second pipes;
inserting the first pipe into a first fin and the second pipe into a second fin;
expanding the first pipe and the second pipe to fix the first pipe to the first fin and the second pipe to the second fin;
cleaning an inside of the heat pipe;
sealing the first end;
injecting working fluid into the second end; and
sealing the second end.

2. The method of claim 1, wherein forming the heat pipe includes bending the third pipe.

3. The method of claim 1, wherein the first fin has a first receiving opening into which the first pipe is inserted, the second fin has a second receiving opening into which the second pipe is inserted, and the first receiving opening is positioned higher in the first fin than the second receiving opening is positioned in the second fin such that the first pipe is coupled to the first fin at a position higher than a position where the second pipe is coupled to the second fin.

4. The method of claim 3, wherein at least one first rib extends from the first fin at the first receiving opening and at least one second rib extends from the second fin at the second receiving opening such that the first rib supports the first pipe and the second rib supports the second pipe.

5. The method of claim 1, further comprising, after the cleaning, drying an inside of the first and second pipes.

6. The method of claim 1, wherein the injecting includes creating a vacuum state in the heat pipe and injecting the working fluid while the heat pipe is in the vacuum state.

7. The method of claim 1, wherein at least one of the first fin or the second fin includes a corrugated fin.

8. The method of claim 1, wherein at least one of the first fin or the second fin includes a slit fin.

9. The method of claim 1, wherein the sealing the first pipe, the injecting, and the sealing the second pipe are performed after the expanding.

10. The method of claim 1, wherein the forming the pipe is performed before the inserting of the first and second pipes, the inserting is performed before the expanding, the expanding is performed before the cleaning, the cleaning is performed before the sealing the first pipe, the sealing the first pipe is performed before the injecting, and the injecting is performed before the sealing the second pipe.

11. The method of claim 1, wherein the first fin is configured to be provided at a first side of an evaporator of the dehumidifier to dissipate heat and the second fin is configured to be provided at a second side of the evaporator to absorb heat.

12. A heat transfer module for a dehumidifier, comprising:
a plurality of heat pipes configured to be arranged in a vertical direction of an evaporator of the dehumidifier, wherein each heat pipe includes a first pipe configured to extend along a first surface of the evaporator, a second pipe configured to extend along a second surface of the evaporator, and a third pipe connecting the first pipe and the second pipe to each other and configured to extend across a side of the evaporator that joins the first and second surfaces;
a first fin coupled to each first pipe and configured to exchange heat with air at the first surface of the evaporator; and
a second fin coupled to each second pipe and configured to exchange heat with air at the second surface of the evaporator, wherein the first pipes are not aligned with the second pipes such that the first pipes are provided at different heights from the second pipes.

13. The heat transfer module of claim 12, wherein the first fin includes:
an opening having a diameter larger than an outer diameter of the first pipe, and
a rib extending from an inner circumferential surface of the first fin that defines the opening, the rib configured to contact an outer circumferential surface of the first pipe when the first pipe is inserted into the opening.

14. The heat transfer module of claim 13, wherein, after the first pipe is inserted into the opening, the first pipe is configured to be expanded to be fixed to the first fin and supported by the rib.

15. The heat transfer module of claim 12, wherein after the first fin and the second fin are coupled to the first pipe and the second pipe, respectively, one of the first fin and the second fin is configured to receive working fluid and then be sealed.

16. The heat transfer module of claim 12, wherein at least one of the first fin or the second fin includes a corrugate fin.

17. The heat transfer module of claim 12, wherein at least one of the first fin or the second fin includes a slit fin.

18. The heat transfer module of claim 12, wherein:
the first fin is configured to absorb heat from the air;
the second fin is configured to dissipate heat to the air; and
the third pipe is inclined such that the first pipe is provided at a lower height than the second pipe.

19. A dehumidifier, comprising:
a case having an inlet and an outlet;
a fan configured to suction air through the inlet and discharge air out the outlet;
an evaporator provided adjacent to the inlet having a first side facing the inlet and second side opposite to the first side; and
a heat transfer module, including:
a first fin provided between the first side of the evaporator and the inlet;
a second fin provided at the second side of the evaporator; and
a plurality of heat pipes, each heat pipe including:
a first pipe penetrating the first fin and configured to exchange heat with air suctioned through the inlet before the air has passed through the evaporator,
a second pipe penetrating the second fin and configured to exchange heat with air that has passed through the evaporator, and
a third pipe joining the first and second pipes and extending across a third side of the evaporator that joins the first and second sides, the third pipe being inclined such that the first pipe is provided below the second pipe.

20. The dehumidifier of claim 19, wherein each heat pipe is configured to be sealed to maintain a vacuum state therein, and a working fluid is provided inside of each pipe.

21. The dehumidifier of claim 19, further comprising a condenser provided at the second side of the evaporator, wherein the second fin is provided between the condenser and the evaporator.
